(19) United States
(12) Patent Application Publication
(10) Pub. No.: US 2014/0175726 A1
(43) Pub. Date: Jun. 26, 2014

(54) RAPIDLY LOCKING/UNLOCKING EXTENSION WORK TABLE

(71) Applicant: Rexon Industrial Corp., Ltd., Taichung (TW)

(72) Inventor: Jung-Huo CHEN, Taichung (TW)

(73) Assignee: REXON INDUSTRIAL CORP., LTD., Taichung (TW)

(21) Appl. No.: 14/136,491

(22) Filed: Dec. 20, 2013

(30) Foreign Application Priority Data
Dec. 25, 2012 (TW) 101149842

(51) Int. Cl. B25B 11/00

(52) U.S. Cl. CPC B25B 11/00
USPC 269/55

(57) ABSTRACT

A rapidly locking/unlocking extension worktable includes a main table, an extension member, a guiding unit and a driving unit. The extension member is movable relative to the main table. The driving unit includes a manipulating member rotatable relative to the extension member, a driving member driven by the manipulating member, a connecting member corresponding to the main table and a locking member connected and movable with the connecting member. When rotating the manipulating member, the driving member is synchronously rotated, the connecting member is driven by the driving member, and the locking member is driven by the connecting member, such that the extension worktable may be rapidly locked or unlocked.

### FIELD OF THE INVENTION

The present invention relates to an extension worktable for machine tool technology, and more particularly to a rapidly locking/unlocking extension worktable.

### BACKGROUND

Referring to FIGS. 1 and 2, an extendable worktable 1 for a machine tool is known for holding a workpiece. The extendable worktable 1 comprises a main table 101, two side extensions 102 respectively mounted at two opposite sides of the main table 101 and movable relative to each other, two pairs of guide rods 103 respectively extended from the side extensions 102 and respectively slidably coupled to the bottom side of the main table 101, two pairs of clamping devices 104 mounted at the bottom side of the main table 101 and respectively attached to the guide rods 103, and two pairs of operating members 105 respectively eccentrically connected to the clamping devices 104 and respectively operable to move the respective clamping devices 104 between a locking position to lock the respective guide rods 103 or an unlocking position to release the respective guide rods 103. When the clamping devices 104 are unlocked from the respective guide rods 103, the side extensions 102 can be moved relative to the main table 101 to adjust the length of the extendable worktable 1 for holding different sizes of workpieces.

However, in order to move the side extensions 102 relative to the main table 101, the user must operate the operating members 105 to unlock the respective clamping devices 104 from the respective guide rods 103. After adjustment of the position of each side extension 102, the user must operate the operating members 105 to lock the respective clamping devices 104 to the respective guide rods 103 again. This procedure is both complicated and inconvenient for a user.

Further, Taiwan Patent Application No. 099117763 (corresponding to US Patent Application Publication No. 2011/0297054, filed by the same applicant of the present invention) discloses an extension worktable that comprises a main table, a side extension movable relative to the main table, at least one first guide bar connected to the side extension, and a locking device rotatably mounted at the side extension and operable to move the side extension between a locking position and an unlocking position. When the locking position is reached, the first guide bar is locked to the main table. When the unlocking position is reached, the first guide bar is released from the main table, thus allowing the user to move the side extension and the first guide bar to adjust the width of the worktable. In addition to the function of connecting the main table and the side extension, the first guide bar can also be rotated relative to the main table between the locking position to lock the side extension to the main table, and the unlocking position to release the side extension from the main table.

### SUMMARY OF THE INVENTION

The present invention has been accomplished under the circumstances in view. It is therefore the main object of the present invention to provide a rapidly locking/unlocking extension worktable, which has a simple structure and is easily operable to change between a locking position and an unlocking position.

To achieve this and other objects of the present invention, a rapidly locking/unlocking extension worktable comprises a main table, an extension member movable relative to the main table, a guide unit connected to the extension member for enabling the extension member to slide relative to the main table, and a driving unit. The driving unit comprises a manipulating member rotatable relative to the extension member, a driving member extended from the extension member to the main table and drivable by the manipulating member, a connecting member corresponding to the main table, and a locking member movable by the connecting member. The driving member extends along an axis line, and is configured to move the connection member in direction perpendicular to the axis line. The connecting member is configured to move the locking member between a locking position to lock the extension member to the main table, and an unlocking position to release the extension member from the main table.

The effect of the invention is that operating the manipulating member of the driving unit can rotate the driving member on the axis line, and simultaneously drive the connecting member and the locking member to lock the extension member to the main table or to unlock the extension member from the main table. The overall structure of the rapidly locking/unlocking extension worktable is simple, and its operation is both easy and convenient.

### BRIEF DESCRIPTION OF THE DRAWINGS

Other advantages and features of the present invention will be understood by reference to the following specification in conjunction with the accompanying drawings, in which like reference characters denote like elements of structure.

FIG. 1 is a top view of a conventional extension worktable for a machine tool.

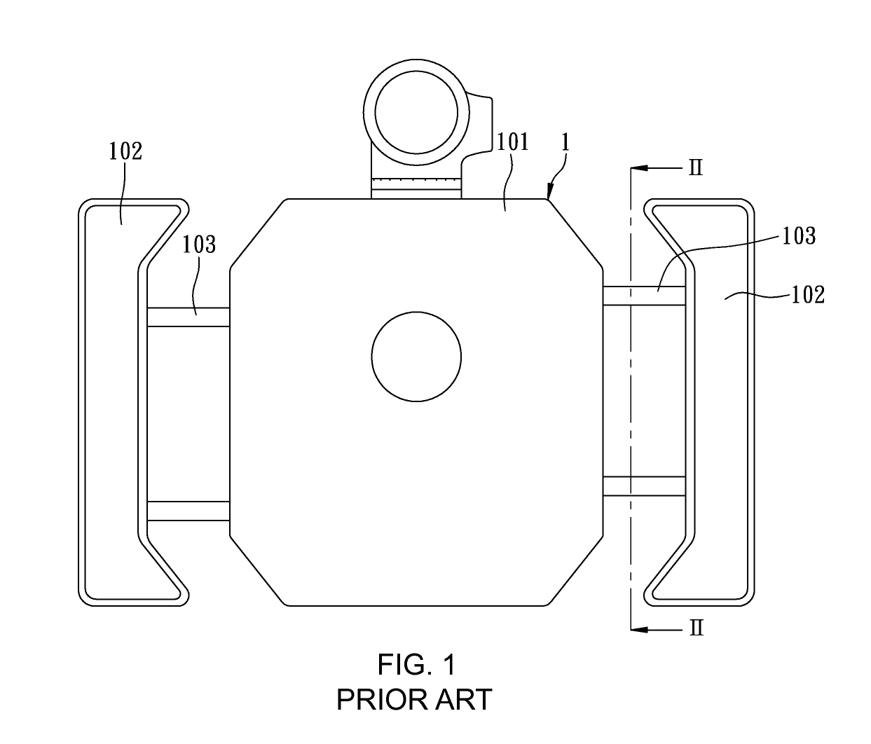

FIG. 2 is a sectional view taken along line II-II of FIG. 1.

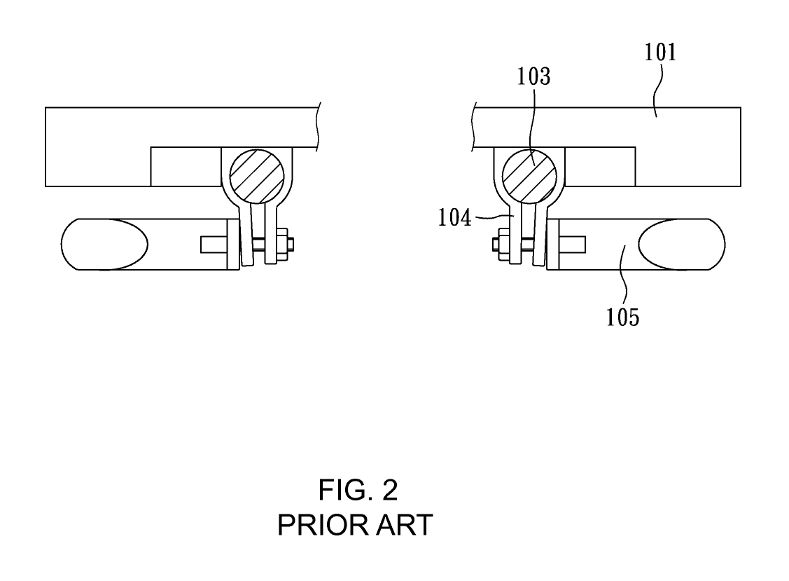

FIG. 3 is a top perspective view of a rapidly locking/unlocking extension worktable in accordance with the present invention.

FIG. 4 is an exploded view of a part of the present invention, illustrating the structure of one guiding unit and one driving unit of the rapidly locking/unlocking extension worktable.

FIG. 5 is a sectional view taken along line V-V of FIG. 3.

FIG. 6 is a sectional view taken along line VI-VI of FIG. 5.

FIG. 7 is a sectional view taken along line VII-VII of FIG. 5.

FIG. 8 is a perspective assembly view of the driving unit of the rapidly locking/unlocking extension worktable in accordance with the present invention.

FIG. 9 corresponds to FIG. 6, illustrating an operation status of the rapidly locking/unlocking extension worktable in accordance with the present invention.

FIG. 10 corresponds to FIG. 7, illustrating an operation status of the rapidly locking/unlocking extension worktable in accordance with the present invention.

FIG. 11 corresponds to FIG. 3, illustrating the adjusted position of the extension member.

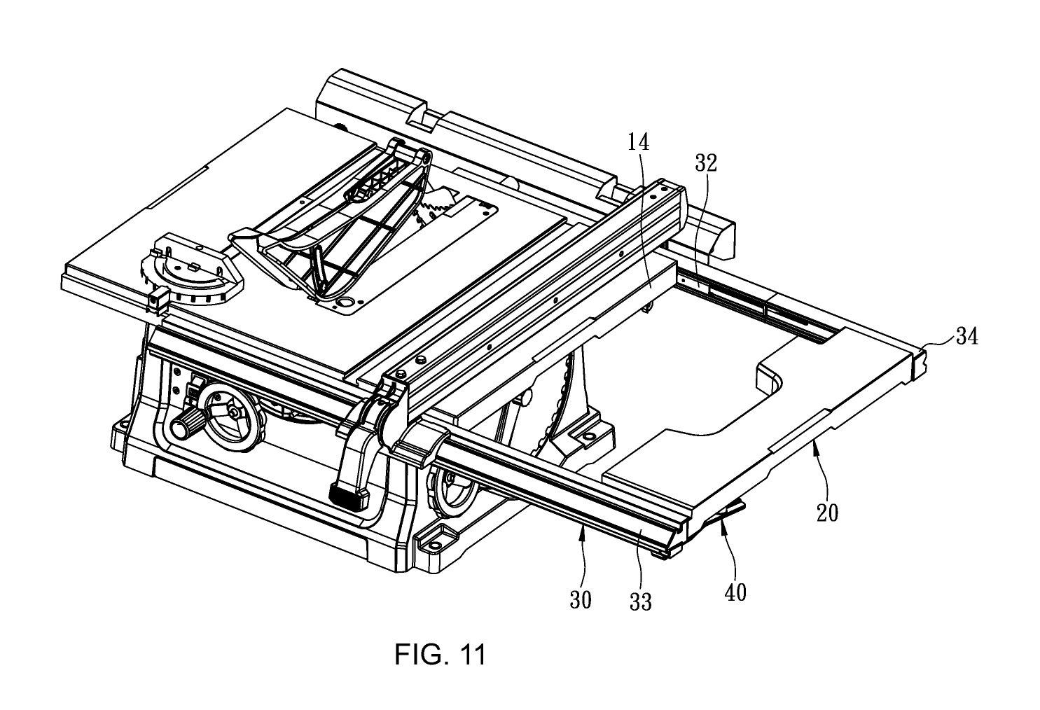

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments of a rapidly locking/unlocking extension worktable and the components thereof, and in no way limit the structures, configurations and components thereof according to the present disclosure.

### DETAILED DESCRIPTION

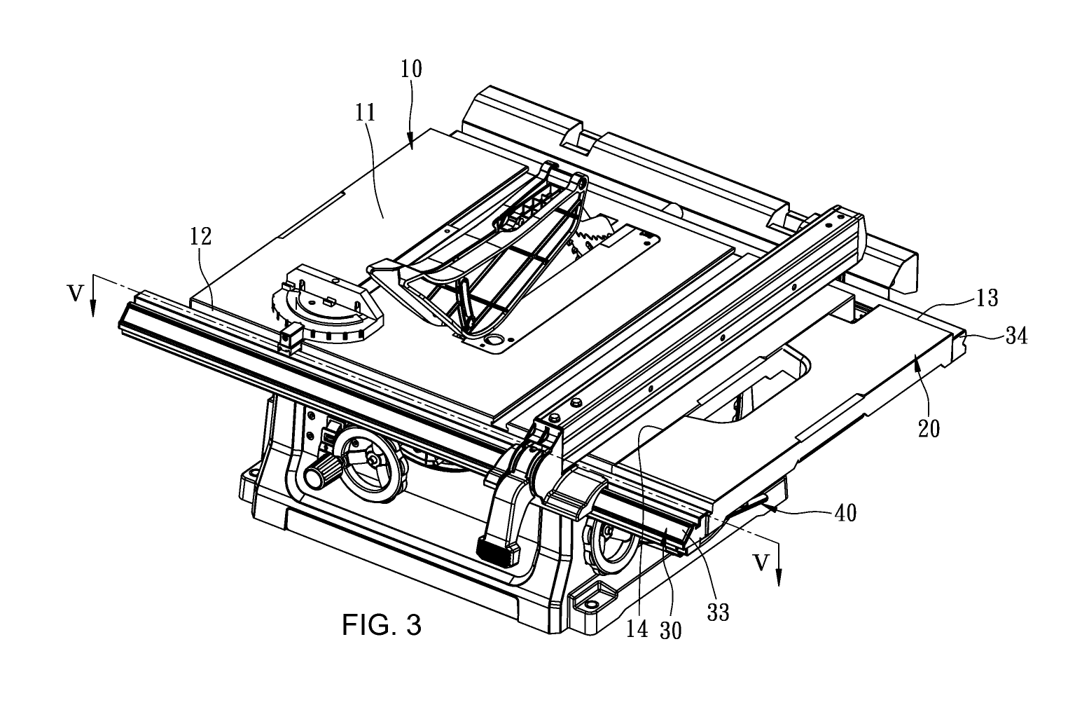

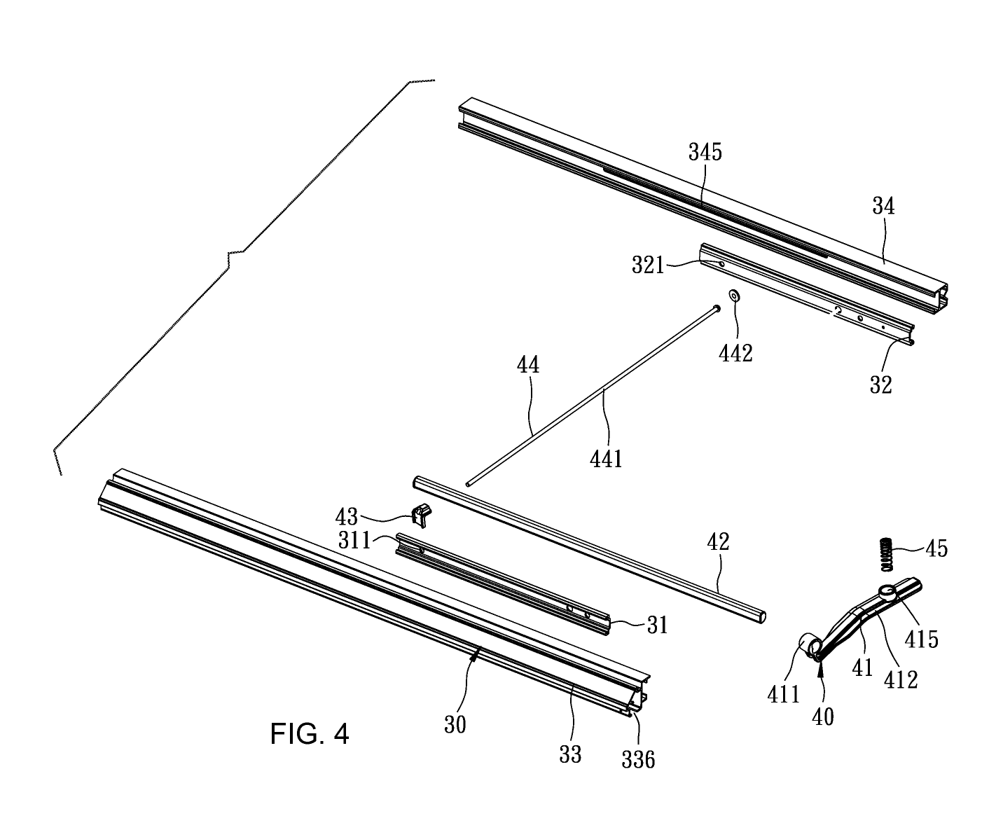

Referring to FIGS. 3 and 4, a rapidly locking/unlocking extension worktable in accordance with the present invention is shown. As illustrated, the rapidly locking/unlocking extension worktable comprises a main table 10, an extension member 20, a guiding unit 30, and a driving unit 40.

The main table 10 defines a top wall 11, a first sidewall 12 which is shown extending perpendicularly from one side of the top wall 11, a second sidewall 13 extending perpendicularly from an opposite side of the top wall 11, and an end wall 14 formed between the first sidewall 12 and the second sidewall 13.

The extension member 20 is located adjacent to the end wall 14 and is movable relative to the end wall 14 of the main table 10.

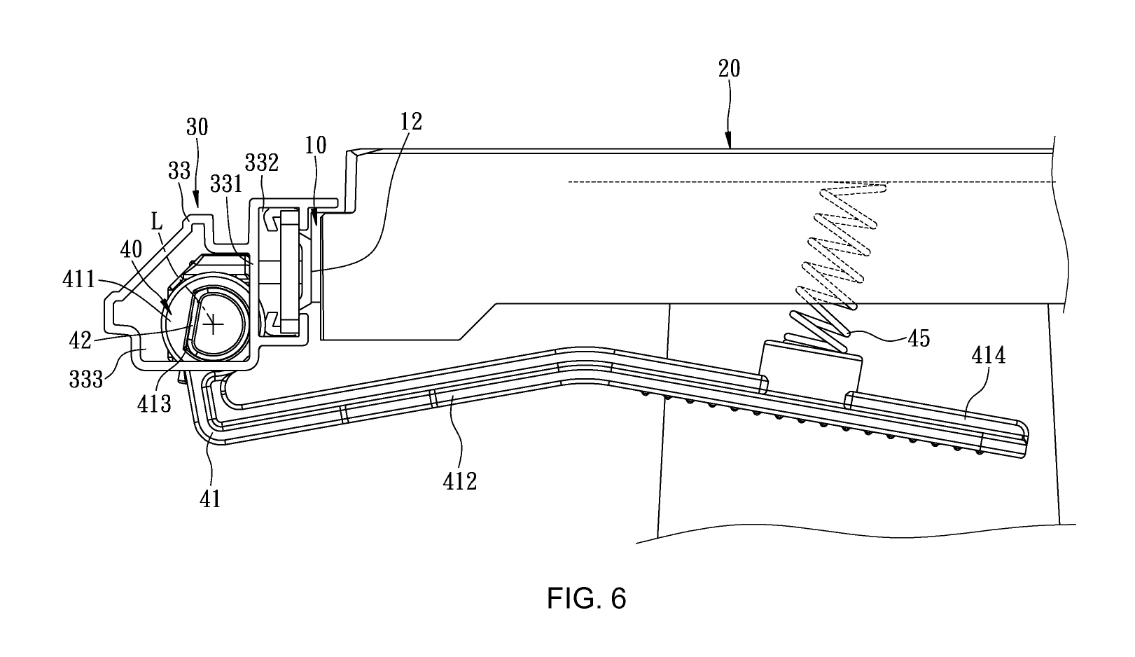

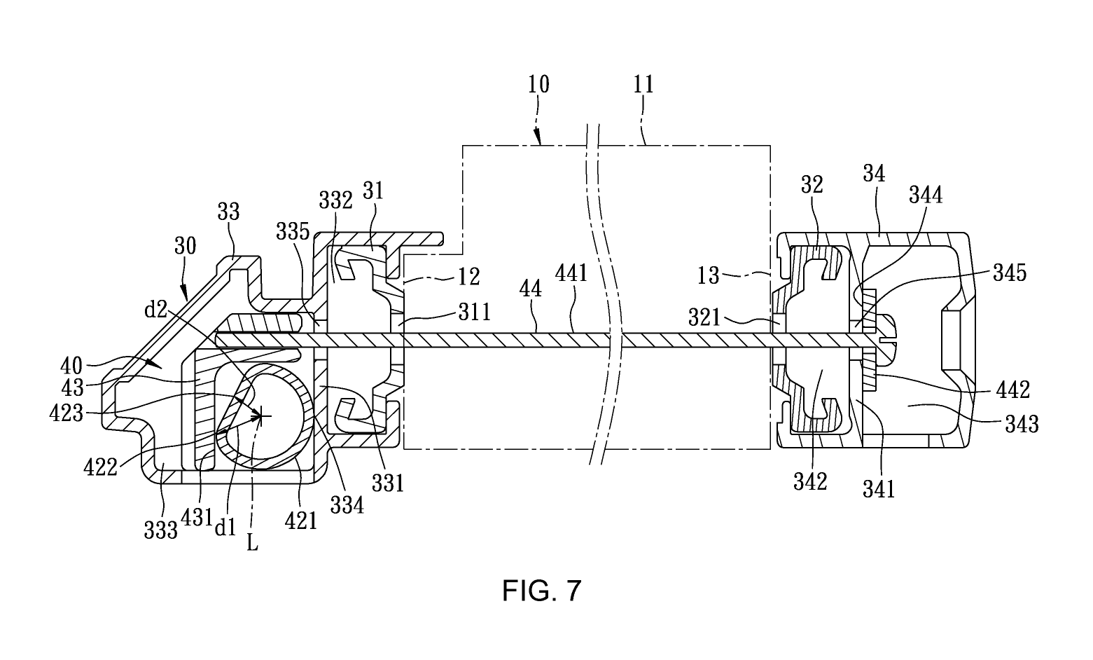

Referring also to FIGS. 6 and 7, the guiding unit 30 is connected to the extension member 20 for enabling the extension member 20 to slide relative to the main table 10. The guiding unit 30 comprises a first guide rail 31 which is affixed to the first sidewall 12, a second guide rail 32 which is affixed to the second sidewall 13, a first sliding bar 33 and a second sliding bar 34 which are slidably coupled to the first guide rail 31 and the second guide rail 32 respectively, and wherein the first sliding bar 33 and the second sliding bar 34 are also connected to the extension member 20. The first guide rail 31, the second guide rail 32, the first sliding bar 33 and the second sliding bar 34 may be aluminum extruded components.

Referring again to FIGS. 4 and 7, the first guide rail 31 has a first through hole 311 defined therein; and the second guide rail 32 has a second through hole 321 defined therein.

The first sliding bar 33 comprises a first partition panel 331 parallely corresponding to the first sidewall 12, a first track 332 which is located at one side of the first partition panel 331, a first chamber 333 which is located at an opposite side of the first partition panel 331, and a first constraint surface 334 which is formed on the first partition panel 331 and which is located adjacent to the first chamber 333. The first partition panel 331 has a first elongated slot 335 defined therein and communicates with the first track 332 and the first chamber 333. The first elongated slot 335 is parallel to the first guide rail 31. The first track 332 is sleevingly coupled to the first guide rail 31. Further, the first sliding bar 33 defines an opening 336 in the bottom side thereof corresponding to one end of the extension member 20.

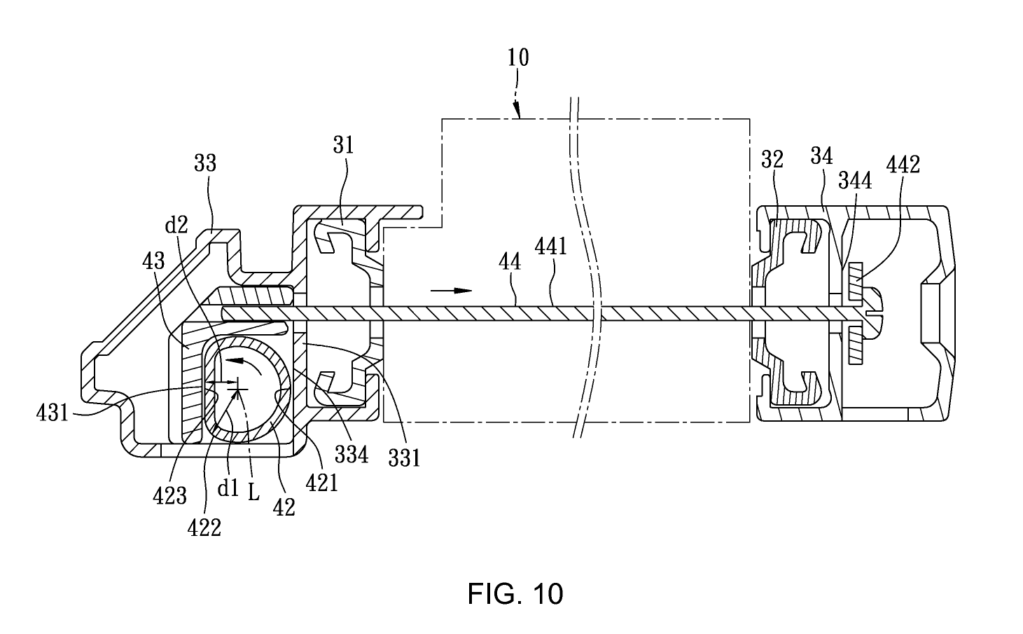

Referring to FIGS. 7 and 10, the second sliding bar 34 comprises a second partition panel 341 parallely corresponding to the second sidewall 13, a second track 342 which is located at one side of the second partition panel 341, a second chamber 343 which is located at an opposite side of the second partition panel 341, a second constraint surface 344 which is formed on the second partition panel 341 and located adjacent to the second chamber 343. The second partition panel 341 has a second elongated slot 345 defined therein and communicates with the second track 342 and the second chamber 343. The second elongated slot 345 is parallel to the second guide rail 32. The second track 342 is sleevingly coupled to the second guide rail 32.

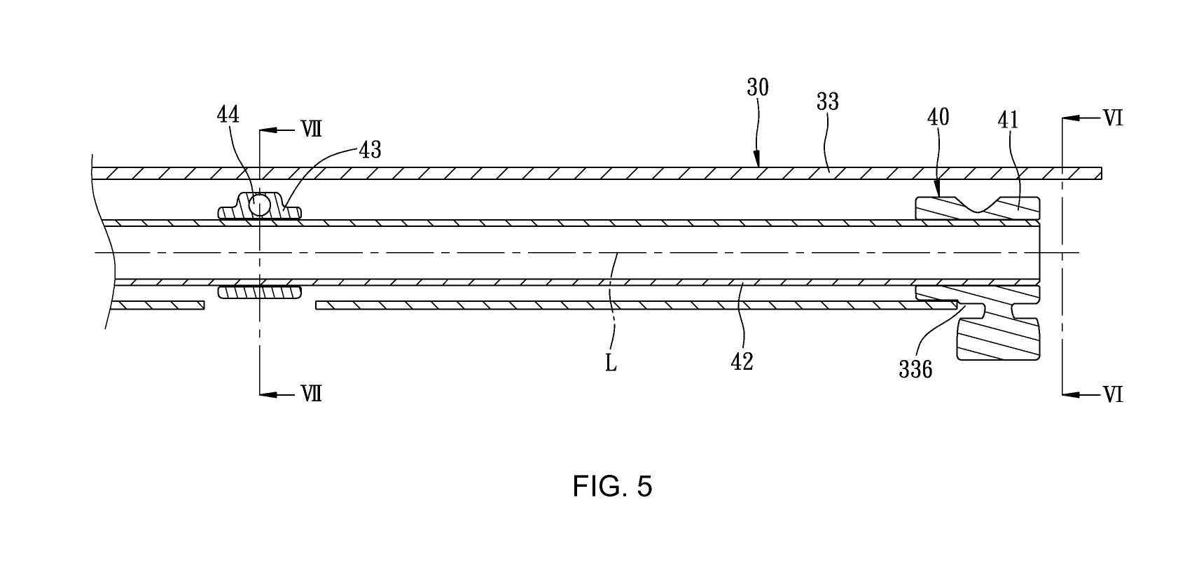

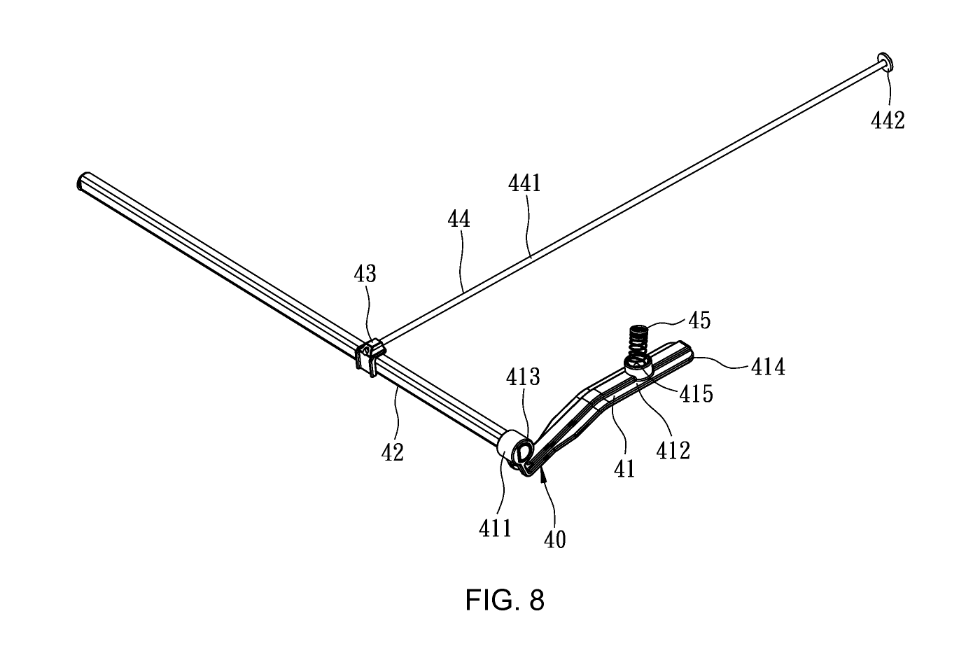

Referring to FIGS. 5-8, the driving unit 40 comprises a manipulating member 41 which is rotatable relative to the extension member 20, a driving member 42 extending from the extension member 20 to the main table 10 and drivable by the manipulating member 41, a connecting member 43 for corresponding to the main table 10, a locking member 44 which is movable by the connecting member 43, and an elastic member 45 which is resiliently located between the extension member 20 and the manipulating member 41.

The manipulating member 41 comprises a barrel 411 which is received in the first chamber 333 and which has a mounting hole 413 having a D-shaped cross section defined therein, and a lever 412 which is connected to the barrel 411 and passes through the opening 336. The lever 412 further has a free end 414 which longitudinally extends toward a bottom of the extension member 20. A receptacle hole 415 is defined in an inner side of the free end 414.

The driving member 42 has a D-shaped cross section and extends along an axis L which is parallel to the first guide rail 31 for biasingly urging the connecting member 43 toward a direction which is generally perpendicular to the axis L. In this embodiment, the driving member 42 is received in the first chamber 333 of the first sliding bar 33. The driving member 42 has an arched portion 421, a driving portion 422, and a release portion 423 surrounding the axis L. The driving portion 422 is located adjacent to the arched portion 421. The release portion 423 is a planar portion which is located between the driving portion 422 and the arched portion 421. A first distance d1 which is formed between the driving portion 422 and the axis L is larger than a second distance d2 which is formed between the release portion 423 and the axis L.

The connecting member 43 is mounted in the first chamber 333 of the first sliding bar 33. The connecting member 43 is L-shaped and is attached to an outer periphery of the driving member 42. The connecting member 43 has a third constraint surface 431 which corresponds to the driving portion 422 and the release portion 423.

The locking member 44 comprises a link 441 and a friction engagement plate 442. The link 441 extends along a perpendicular direction relative to the axis L, and two opposite ends of the link 441 are respectively connected to the connecting member 43 and the friction engagement plate 442. The two opposite ends of the link 441 respectively pass through the first through hole 311 of the first guide rail 31 and the second through hole 321 of the second guide rail 32, and also respectively pass through the first elongated slot 335 of the first sliding bar 33 and the second elongated slot 345 of the second sliding bar 34. The friction engagement plate 442 is located in the second chamber 343 of the second sliding bar 34 for corresponding to the second partition panel 341 and the second constraint surface 344. By means of inserting the link 441 into the main table 10, the connecting member 43 is positioned in the main table 10 corresponding to the axis line L.

The elastic member 45 may be a compression spring, having one end received in the receptacle hole 415 of the manipulating member 41, and its other end abutting against the bottom side of the extension member 20. A restoring force of the elastic member 45 resiliently and constantly positions the extension member 20 relative to the main table 10.

FIG. 3 illustrates the extension worktable in the minimum length. At this time, the extension member 20 is kept close to the end wall 14 of the main table 10. Further, as shown in FIGS. 6 and 7, due to the restoring force of the elastic member 45 that acts upon the lever 412 of the manipulating member 41, the free end 414 of the manipulating member 41 is oriented away from the bottom side of the extension member 20 at a distance, and the driving member 42 is driven by the barrel 411 such that the arched portion 421 abuts against the first constraint surface 334 of the first partition panel 331, and the driving portion 422 abuts against the third constraint surface 431 of the connecting member 43 for urging the connecting member 43 to move closer toward the left side shown in FIG. 7. The link 441 is therefore driven by the connecting member 43, such that the link 441 is also moved toward the left side shown in FIG. 7. Thus, the friction engagement plate 442 is driven by the link 441 to clamp the second constraint surface 344 of the second partition panel 341. At this time, the locking member 44 locks the first sliding bar 33 and the second sliding bar 34 of the guiding unit 30 to the main table 10 for refraining the extension member 20 from sliding, and the extension member 20 is therefore securely positioned to the main table 10.

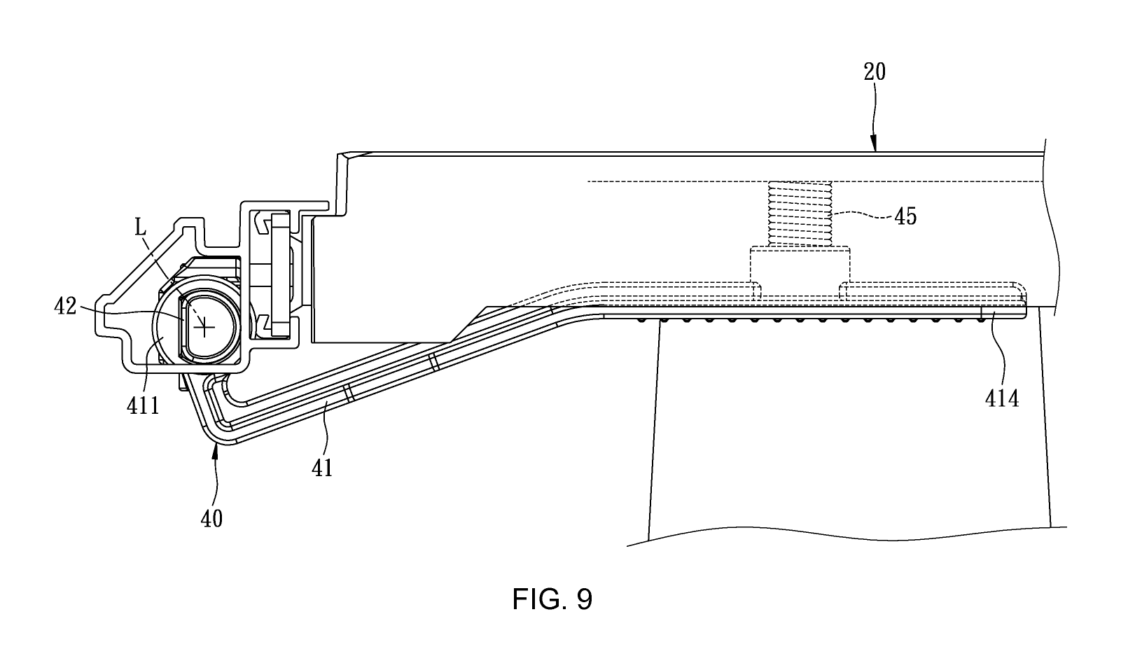

When a user wants to adjust the working length of the extension worktable by pressing the free end 414 of the manipulating member 41 toward the extension member 20, as shown in FIGS. 9 and 10, the elastic member 45 is compressed, thereby rotatably moving the driving member 42 by the barrel 411 for rotating the release portion 423 into abutment with the third constraint surface 431. Due to the first distance d1 between the driving portion 422 and the axis L being larger than the second distance d2 between the release portion 423 and the axis L, the arched portion 421 is not in contact with the first constraint surface 334 of the first partition panel 331, and the driving portion 422 is also not in contact with the third constraint surface 431 of the connecting member 43. Thus, the connecting member 43 and the link 441 are released, and the friction engagement plate 442 is disengaged from the second constraint surface 344 of the second partition panel 341. Therefore, the locking member 44 is unlocked, which allows the extension member 20 to slide relative to the main table 10. Thus, the first sliding bar 33 and the second sliding bar 34 of the guiding unit 30 are slidably movable relative to the main table 10, and the user can pull the extension member 20 outwards relative to the main table 10 to adjust the desired working length of the extension worktable.

Upon adjustment, the user may release the manipulating member 41, which enables the restoring force of the elastic member 45 to resiliently urge the manipulating member 41, thus causing the driving member 42 to rotate about the axis L. At this time, the arched portion 421 is driven to once again abut against the first constraint surface 334 of the first partition panel 331, and the driving portion 422 is driven to abut against the third constraint surface 431 of the connecting member 43 to move the link 441 in a direction perpendicular to the axis L and toward the second sliding bar 34 of the guiding unit 30, thus forcing the friction engagement plate 442 into engagement with the second constraint surface 344 of the second sliding bar 34, and thereby locking the extension member 20 to the main table 10 again, as shown in FIGS. 6 and 7.

Therefore, under normal conditions, the restoring force of the elastic member 45 constantly biases the driving portion 422 of the driving member 42 for retaining the connecting member 43, causing the connecting member 43 to force the friction engagement plate 442 into engagement with the second constraint surface 344 of the second sliding bar 34 for securely positioning the extension member 20 to the main table 10. Pressing the free end 414 of the manipulating member 41 releases the driving member 42 from abutment with the third constraint surface 431 of the connecting member 43, enabling the link 441 to be moved by the connecting member 43 to disengage the friction engagement plate 442 from the second constraint surface 344 of the second sliding bar 34. The extension member 20 can be simultaneously moved such that the first sliding bar 33 and the second sliding bar 34 respectively slides along the first guide rail 31 and the second guide rail 32 for adjusting the position of the extension member 20 relative to the main table 10. The present invention therefore has a simple structure, and can be easily operated with a single hand.

It is worth mentioning that the guiding unit 30 is configured to connect the extension member 20 and the main table 10, thus enabling the extension member 20 to slide relative to the main table 10. The driving unit 40 uses the manipulating member 41 that is rotatable relative to the extension member 20, such that the extension member 20 co-operates with the driving member 42, the connecting member 43 and the locking member 44 to be movable by the manipulating member 41. This enables the extension member 20 to be locked to, or unlocked from, the main table 10. Thus, the effects of the guiding unit 30 and driving unit 40 are quite different from that of the first guide bar and the driving unit disclosed in the cited reference Taiwan Patent Application Publication No. 201143998.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A rapidly locking/unlocking extension worktable, comprising:
a main table;
an extension member movable relative to said main table;
a guide unit connected to said extension member for enabling said extension member to slide relative to said main table; and
a driving unit comprising a manipulating member rotatable relative to said extension member, a driving member extended along an axis from said extension member to said main table and drivable by said manipulating member, a connecting member corresponding to said main table and a locking member movable by said connecting member;
wherein said driving member is configured to move said connecting member in a direction perpendicular to said axis, and wherein said connecting member moves said locking member between a locking position and an unlocking position for selectively locking or unlocking said extension member to said main table.

2. The rapidly locking/unlocking extension worktable as claimed in claim 1, wherein said driving member of said driving unit comprises a driving portion and a release portion surrounding said axis and located adjacent to said driving portion, and wherein a first distance formed between said driving portion and said axis being larger than a second distance formed between said release portion and said axis.

3. The rapidly locking/unlocking extension worktable as claimed in claim 2, wherein said connecting member is selectively engaged to said driving member, said connecting member comprising a constraint surface for corresponding to said driving portion and said release portion.

4. The rapidly locking/unlocking extension worktable as claimed in claim 3, said locking member comprising a link connected to said connecting member in the direction perpendicular to said axis, and a friction engagement plate connected to said link, wherein said link is inserted into said main table; and
wherein, by pressing said manipulating member, said driving member is rotatably driven about said axis, such that said driving portion abuts against said constraint surface for driving said connecting member and said link to move in the direction perpendicular to said axis and toward said guiding unit to an extent where said friction engagement plate is forced into engagement with said guiding unit; by releasing said manipulating member, said driving member is rotated in one direction, said release portion being forced against said constraint surface to move said connecting member and said link in the direction perpendicular to said axis line and away from said guiding unit to the extent where said friction engagement plate is disengaged from said guiding unit when said driving member in rotated in the reversed direction.

5. The rapidly locking/unlocking extension worktable as claimed in claim 4, wherein said driving member of said driving unit has a D-shaped cross section, and an arched portion surrounding said axis.

6. The rapidly locking/unlocking extension worktable as claimed in claim 5, wherein said release portion has a planar shape surrounding said axis and located between said arched portion and said driving portion.

7. The rapidly locking/unlocking extension worktable as claimed in claim 6, wherein said connecting member is L-shaped, and attached to an outer side of said driving member.

8. The rapidly locking/unlocking extension worktable as claimed in claim 1, wherein said main table comprises a first sidewall, and a second sidewall opposite to said first sidewall; and said guiding unit comprises a first guide rail affixed to said first sidewall, a second guide rail affixed to said second sidewall, a first sliding bar and a second sliding bar respectively and slidably coupled to said first guide rail and connected to said extension member, such that said driving member is inserted into said first sliding bar.

9. The rapidly locking/unlocking extension worktable as claimed in claim 8, wherein said first guide rail, said second guide rail, said first sliding bar and said second sliding bar are aluminum extruded components.

10. The rapidly locking/unlocking extension worktable as claimed in claim 8, wherein said first sliding bar has a first chamber defined therein, a first partition panel arranged in parallel to said first sidewall and a first constraint surface located at said first partition panel adjacent to said first chamber; said second sliding bar has a second chamber defined therein, a second partition panel arranged in parallel to said second sidewall and a second constraint surface located at said second partition panel adjacent to said second chamber; and said connecting member comprises a third constraint surface corresponding to said driving portion and said release portion;
wherein, when said locking member is driven by said driving member to lock said extension member to said main table, said arched portion of said driving member abuts against said first constraint surface, and said driving portion of said driving member abuts against said third constraint surface for driving said link and urging said friction engagement plate into engagement with said third constraint surface when said driving member forces said locking member to lock said guiding unit to said main table.

11. The rapidly locking/unlocking extension worktable as claimed in claim 10, wherein said link passes through said first guide rail and said second guide rail; said first sliding bar has a first elongated slot arranged in parallel to said first guide rail; said second sliding bar has a second elongated slot arranged in parallel to said second guide rail; and said link passes through said first elongated slot and said second elongated slot.

12. The rapidly locking/unlocking extension worktable as claimed in claim 1, wherein said driving unit further comprises an elastic member resiliently located between said extension member and said manipulating member for resiliently and constantly positioning said extension member relative to said main table.

13. The rapidly locking/unlocking extension worktable as claimed in claim 8, wherein said driving unit further comprises an elastic member resiliently located between said extension member and said manipulating member for resiliently and constantly positioning said extension member relative to said main table.
